(19) United States
(12) Patent Application Publication
(10) Pub. No.: US 2025/0284549 A1
(43) Pub. Date: Sep. 11, 2025

(54) WORKLOAD MANAGEMENT VIA ADAPTIVE REQUEST RATE LIMITING

(71) Applicant: Red Hat, Inc., Raleigh, NC (US)

(72) Inventors: Andrew David Mackenzie, Madrid (ES); Sergio Lopez Mateos, Madrid (ES)

(21) Appl. No.: 18/601,633

(22) Filed: Mar. 11, 2024

(51) Int. Cl. G06F 9/50

(52) U.S. Cl. CPC G06F 9/5033; G06F 9/5044

(57) ABSTRACT

A determination is made that a quantity of computing resources utilized by a set of existing workloads is greater than a threshold quantity of the computing resources. Responsive to the determination, a particular rate limiting target is identified from a plurality of rate limiting targets of a rate limiting policy, wherein the rate limiting policy controls a workload management Application Programming Interface (API) that receives workload requests from requesting entities, and wherein the plurality of rate limiting targets comprises a particular workload type, a particular requesting entity, or a particular requesting entity type. The rate limiting policy is modified, wherein modifying the rate limiting policy comprises replacing an existing rate limit for the rate limiting target with a modified rate limit different than the existing rate limit.

### BACKGROUND

Certain organizations operate computing environments in which computing operations are organized as workloads. The computing environment has limited computing resources available, determined by hardware installed. A workload generally refers to a set of computing operations and/or processes that are performed to accomplish a particular task (e.g., compilation workloads, rendering workloads, machine learning workloads, etc.). Workloads are triggered by requests coming from outside the computing environment. The quantity, and/or type, of computing resources necessary to accomplish a particular workload can vary based on the type of workload. For example, a workload that routinely collects sensor data from an Internet-of-Things (IoT) device would likely require substantially fewer (and different) computing resources than a workload for training a machine-learned computer vision model. One advantage to a workload-based computing environment is that tasks can be easily automated. For larger organizations, automated workloads can utilize a substantial proportion of available computing resources. The computing resources consumed by the workloads at any given point in time is limited by the resources available. When the work demanded (via requests) would consume more than the available resources, decisions must be made to limit the work and resource consumption.

### SUMMARY

A workload management computing system can identify a rate limiting target based on current computing resource utilization. The computing system can modify the rate limit for the identified rate limiting target within a rate limiting policy that controls a workload management API. By modifying rate limits for the rate limiting policy based on resource utilization, the workload management computing system can dynamically prioritize certain types of workloads, and/or workloads from certain types of entities.

In one implementation, a method is provided. The method includes making, by a workload management computing system comprising one or more processor devices, a determination that a quantity of computing resources utilized by a set of existing workloads is greater than a threshold quantity of the computing resources. The method includes, responsive to the determination, identifying, by the workload management computing system, a particular rate limiting target from a plurality of rate limiting targets of a rate limiting policy, wherein the rate limiting policy controls a workload management Application Programming Interface (API) that receives workload requests from requesting entities, and wherein the plurality of rate limiting targets comprises a particular workload type, a particular requesting entity, or a particular requesting entity type. The method includes modifying, by the workload management computing system, the rate limiting policy, wherein modifying the rate limiting policy comprises replacing an existing rate limit for the rate limiting target with a modified rate limit different than the existing rate limit.

In another implementation, a workload management computing system is provided. The workload management computing system includes a memory, and processor device(s) coupled to the memory. The processor device(s) are to make a determination that a quantity of computing resources utilized by a set of existing workloads is greater than a threshold quantity of the computing resources. The processor device(s) are further to, responsive to the determination, identify a particular rate limiting target from a plurality of rate limiting targets of a rate limiting policy, wherein the rate limiting policy controls a workload management API that receives workload requests from requesting entities, and wherein the plurality of rate limiting targets comprises a particular workload type, a particular requesting entity, or a particular requesting entity type. The processor device(s) are further to modify the rate limiting policy, wherein modifying the rate limiting policy comprises replacing an existing rate limit for the rate limiting target with a modified rate limit different than the existing rate limit.

In another implementation, a non-transitory computer-readable storage medium is provided. The non-transitory computer-readable storage medium includes executable instructions to cause one or more processor devices to make a determination that a quantity of computing resources utilized by a set of existing workloads is greater than a threshold quantity of the computing resources. The instructions further cause the processor device(s) to, responsive to the determination, identify a particular rate limiting target from a plurality of rate limiting targets of a rate limiting policy, wherein the rate limiting policy controls a workload management API that receives workload requests from requesting entities, and wherein the plurality of rate limiting targets comprises a particular workload type, a particular requesting entity, or a particular requesting entity type. The instructions further cause the processor device(s) to modify the rate limiting policy, wherein modifying the rate limiting policy comprises replacing an existing rate limit for the rate limiting target with a modified rate limit different than the existing rate limit.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 is a block diagram of an environment suitable for implementing workload management via adaptive request rate limiting according to some implementations of the present disclosure.

FIG. 2 is a communication flow diagram between a requesting entity and a workload management computing system mediated by a workload management Application Programming Interface (API) according to some implementations of the present disclosure.

FIG. 3 is a flowchart of a method for workload management via adaptive request rate limiting according to some implementations of the present disclosure.

FIG. 4 is a simplified block diagram of the environment illustrated in FIG. 1 according to one implementation of the present disclosure.

FIG. 5 is a block diagram of the workload management computing system suitable for implementing examples according to one example.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples and claims are not limited to any particular sequence or order of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B. The word “data” may be used herein in the singular or plural depending on the context. The use of “and/or” between a phrase A and a phrase B, such as “A and/or B” means A alone, B alone, or A and B together.

Certain organizations operate computing environments in which computing operations are organized as workloads. A workload generally refers to a set of computing operations and/or processes that are performed to accomplish a particular task (e.g., compilation workloads, rendering workloads, machine learning workloads, etc.). The quantity, and/or type, of computing resources necessary to accomplish a particular workload can vary based on the type of workload. For example, a workload that routinely processes sensor data from an Internet-of-Things (IoT) device would likely require substantially fewer (and different) computing resources than a workload for training a machine-learned computer vision model. One advantage to a workload-based computing environment is that tasks can be easily automated. For larger organizations, automated workloads can utilize a substantial proportion of available computing resources.

Workload-based computing environments often utilize virtualization processes to fulfill workload requests. For example, upon receipt of a workload request for a database backup workload, a computing system may instantiate a particular virtual machine or container to fulfill the database backup workload. In some instances, a particular container or virtual machine can be configured to perform a corresponding workload. To follow the previous example, the computing system may instantiate a container configured to fulfill the database backup workload (e.g., by including database software, database access credentials, etc.). In this manner, some workloads can be parallelized by instantiating multiple instances of a particular virtual machine or container based on an available quantity of computing resources.

In many workload-based computing environments, workload demand is dynamic and can often fluctuate between periods of low demand and high demand. In turn, such periods can respectively lead to resource under-utilization and resource over-utilization. For example, if two developers within a small organization submit demanding workload requests at the same time (e.g., compilation workloads, rendering workloads, etc.), computing resources can quickly transition from being under-utilized to being over-utilized, thus degrading performance. In addition, rapid transitions to resource over-utilization can cause some (or all) affected workloads to fail, or can negatively impact non-associated workloads running in the same environment.

As such, computing resource utilization for many organizations is relatively inefficient. This problem is exacerbated by the difficulty of characterizing workloads. More specifically, determining how much (and what type of) work a workload requires prior to fulfillment of the workload can be prohibitively expensive, and as such, computing systems often cannot accurately predict the type and/or quantity of computing resources necessary to fulfill a workload request.

For example, two cryptographic workloads may appear similar upon request, but one workload might primarily utilize Central Processing Units (CPUs) while the other might primarily utilize Graphics Processing Units (GPUs). For another example, assume that a workload gathers and processes user information (e.g., historical user actions, files submitted by the user, etc.), and that two workload requests are received for two user accounts. Despite both requests being identical, the computational resources required to fulfill both requests can differ by orders of magnitude based on the ages of the accounts (and thus, the quantity of data to be gathered). As such, scheduling workload fulfillment based solely on workload characterization is often ineffective.

When fluctuations in computing resource demand cause over-utilization of computing resources, such over-utilization can degrade computing performance by causing workloads to fail, or by reducing workload completion speed. Over-utilization of computing resources can be exacerbated by the high quantity of automated workloads routinely scheduled for certain organizations (e.g., information backup workloads, etc.). For example, a workload request for machine-learned model training can be slowed considerably if a scheduled database backup workload begins during fulfillment of the training workload.

Generally, an automated workload delaying completion of a requested workload may be viewed as acceptable. However, in some scenarios (e.g., approaching development deadlines, fixing live services, “crunch” periods, etc.), minimizing delays caused by autonomous workload fulfillment is critical. Minimizing such delays cannot be accomplished without the capability to prioritize certain types of workload requests, or requests from certain entities/types of entities. In addition, some requesting technologies (e.g., Hypertext Transfer Protocol (HTTP)) include timeout mechanisms that will cancel the request if a response is not received in a certain time period. As such, a technique to efficiently manage workload requests is desired.

Accordingly, implementations described herein propose workload management via adaptive request rate limiting. More specifically, a computing system within a workload-based computing environment can receive a workload request from a requesting entity (e.g., a user, an automated process, etc.) via an interface, such as an Application Programming Interface (API) (e.g., a workload management API). The workload request can indicate a workload of a particular workload type. For example, the workload request may indicate a machine-learning workload type, a rendering workload type, a cryptographic workload type, a quantum workload type, etc.

The computing system can make a determination that a quantity of computing resources utilized by an existing set of workloads is greater than a threshold quantity of computing resources. For example, the computing system may already be in the process of fulfilling previously requested workloads upon receipt of the workload request. Those workloads being fulfilled can utilize a certain quantity of computing resources (e.g., 80% of total resources, 50% of a particular resource (e.g., CPUs, GPUs, etc.), etc.). The computing system can determine whether that quantity is greater than the threshold quantity, or alternatively, whether accepting the request may lead to over-utilization of the computing resources.

As described previously, workload requests can be received by a workload management computing system. For example, the workload requests can be received via an interface (e.g., an API, etc.), such as a workload management API that receives and manages workload requests from requesting entities. In some implementations, the workload management API can be implemented by the computing system to limit the rate at which requests are fulfilled.

The workload management computing system can make workload fulfillment decisions based on a rate limiting policy. The rate limiting policy can indicate rate limits for particular rate limiting targets. As described herein, a “rate limiting target” refers to some identifying characteristic of a workload request, and/or the requesting entity that submits the workload request. Rate limiting targets can include a particular workload type, a particular requesting entity, a particular entity type associated with the requesting entity, etc.

By assigning a rate limit to a particular rate limiting target, the rate limiting policy can control the rate at which workloads associated with the rate limiting target are accepted or rejected by the workload management computing system. In some implementations, a rate limit can control the number of workloads associated with the rate limiting target that can be fulfilled within a period of time. Additionally, or alternatively, in some implementations, the rate limit can control the resource types and/or quantity of computing resources currently available to fulfill workloads associated with the rate limiting target. For example, the rate limit can control a total quantity of GPU resources available to fulfill cryptographic workload requests, or a quantity of GPU resources available to fulfill each cryptographic workload request. For another example, the rate limit can control a number of virtualized instances allocated to fulfillment of cryptographic workload requests.

The computing system can dynamically modify the rate limiting policy by modifying the rate limits for rate limiting targets. More specifically, the computing system can modify the rate limiting policy by replacing an existing rate limit for the identified rate limiting target with a modified rate limit. For example, assume that the identified rate limiting target is a cryptographic workload type, and that the existing rate limit allocates a certain quantity of GPU resources to fulfill cryptographic workload requests. If the total quantity of GPU resources within the computing environment is reduced (e.g., due to hardware failure, power failure, etc.), the computing system can replace the existing rate limit with a modified rate limit that allocates fewer GPU resources to fulfill cryptographic workload requests. In such fashion, the computing system can dynamically modify rate limits on a per-target basis in response to changes in computing resource availability and/or utilization.

Implementations described herein provide a number of technical effects and benefits. As one example technical effect and benefit, the present implementations can facilitate more efficient utilization of computing resources within a computing environment. For example, without the ability to dynamically manage rate limits, workload management systems are often forced to reserve a certain quantity of computing resources for high-importance tasks to avoid delays in performing those tasks, and since such tasks are usually rare, the reserved computing resources go mostly unutilized. However, implementations described herein utilize a dynamically managed rate limiting policy to prioritize high-importance tasks, thus obviating the need for reserved computing resources.

As another example technical effect and benefit, implementations described herein provide the capability to dynamically prioritize workload fulfillment based on entity type during time-sensitive scenarios. More specifically, it is relatively common for routine fulfillment of workload requests from automated entities to substantially delay fulfillment of workload requests from user entities (e.g., engineers, developers, etc.). In some instances, such delays are acceptable. During time-sensitive scenarios (e.g., “crunch” time, deployment of live services, patch deployment, repairing network services, etc.), however, eliminating sources of delays to user entities can be critical. In particular, delaying requests from users can substantially degrade user experience and even the usability of the system. Accordingly, implementations described herein can dynamically prioritize workload requests from user entities over those received from automated entities, thus eliminating a source of substantial delays during time-sensitive scenarios.

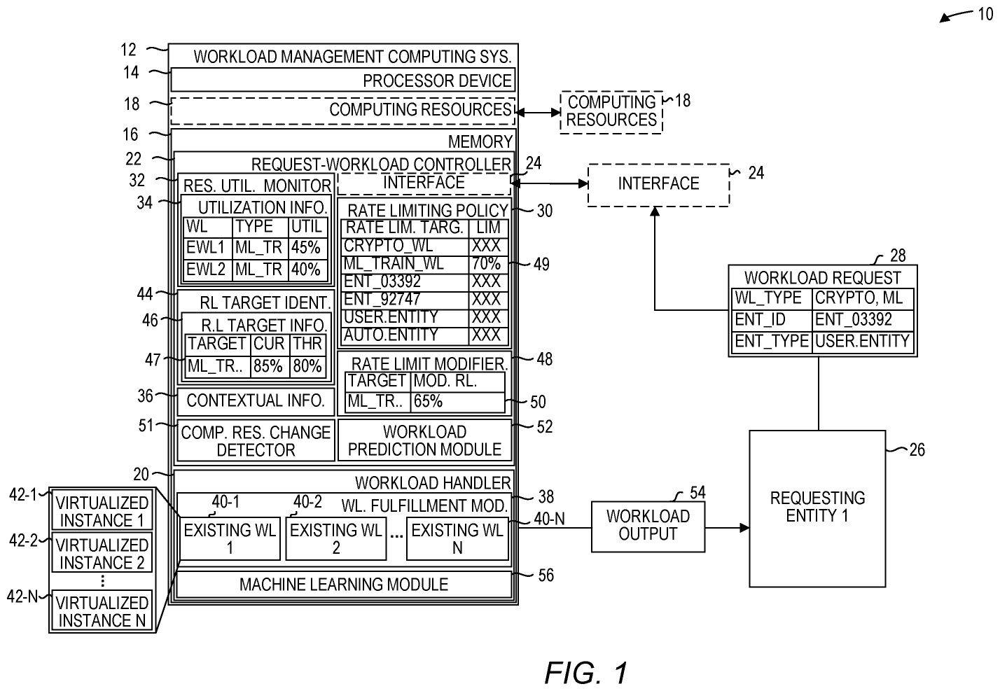

FIG. 1 is a block diagram of an environment suitable for implementing workload management via adaptive request rate limiting according to some implementations of the present disclosure. In some implementations, a computing environment 10 includes a workload management computing system 12. The workload management computing system 12 can be a system for managing workloads in the computing environment 10, and can include a processor device(s) 14 and memory 16. In some implementations, the workload management computing system 12 may be a computing system that includes multiple computing devices. Alternatively, in some implementations, the workload management computing system 12 may be one or more computing devices within the computing environment 10 that includes multiple distributed devices and/or systems. Similarly, the processor device(s) 14 may include any computing or electronic device capable of executing software instructions to implement the functionality described herein.

The memory 16 can be or otherwise include any device(s) capable of storing data, including, but not limited to, volatile memory (random access memory, etc.), non-volatile memory, storage device(s) (e.g., hard drive(s), solid state drive(s), etc.). In particular, the memory 16 can include a containerized unit of software instructions (i.e., a “packaged container”). The containerized unit of software instructions can collectively form a container that has been packaged using any type or manner of containerization technique.

The containerized unit of software instructions can include one or more applications, and can further implement any software or hardware necessary for execution of the containerized unit of software instructions within any type or manner of computing environment. For example, the containerized unit of software instructions can include software instructions that contain or otherwise implement all components necessary for process isolation in any environment (e.g., the application, dependencies, configuration files, libraries, relevant binaries, etc.).

In some implementations, the workload management computing system 12 can include computing resources 18. Additionally, or alternatively, in some implementations, the workload management computing system 12 can access the computing resources 18 from some other location within the computing environment 10. As described herein, the computing resources 18 can generally refer to any type, manner, or collection of physical and/or virtualized devices, software, instructions, modules, etc. The computing resources 18 can include processing devices (e.g., Central Processing Units (CPUs), Graphics Processing Units (GPUs), Application-specific Integrated Circuits (ASICs), Field-Programmable Gate Arrays (FPGAs), virtualized processing device(s), accelerator devices, qubits, etc.), network resources (e.g., bandwidth, etc.), storage devices or systems, (e.g., memory, hard disks, databases, etc.), software resources (e.g., machine-learned model instances, application instances, etc.), etc.

The memory 16 can include a workload handler 20. The workload handler 20 can fulfill workloads indicated by workload requests. For example, the workload handler 20 can instantiate containers configured to fulfill particular types of workload requests, and can utilize the computing resources 18 to do so. The workload handler 20 will be discussed in more detail further below in the specification.

As described herein, a “workload” generally refers to a set of computing operations and/or processes that are performed to accomplish a particular task (e.g., compilation workloads, rendering workloads, machine learning workloads, etc.). The quantity, and/or type, of computing resources necessary to accomplish a particular workload can vary based on the workload type. For example, a workload that routinely collects sensor data from an Internet-of-Things (IoT) device would likely require substantially fewer (and different) computing resources than a workload for training a machine-learned computer vision model.

The memory 16 can include a request-workload controller 22. The request-workload controller 22 can receive and manage workload requests. Workload requests can be received from requesting entities, and can request that a particular workload be fulfilled by the workload management computing system 12. Specifically, the request-workload controller 22 can include, implement, or otherwise communicate with an interface 24. The interface 24 can be configured to receive workload requests from requesting entities. Requesting entities can submit workload requests via the interface. For example, the interface 24 can be a Representational State Transfer (REST) API, and the workload request can be a structured data object (e.g., a Javascript Object Notation (JSON) object, etc.) that indicates a particular workload to be fulfilled (or is otherwise descriptive of a workload to be fulfilled).

In some implementations, a workload request can include, and/or indicate, data to be processed at the workload management computing system 12. For example, if the workload request indicates a machine-learned model training workload, the workload request can include a corpus of training data to be utilized for the training workload. For another example, if the workload request is a data storage workload, the workload request may point to a location from which the data can be retrieved for storage.

In some implementations, a workload request can include executable software instructions. For example, if the workload request is a compilation workload, the workload can include a codebase that is to be compiled. Additionally, or alternatively, in some implementations, the workload request can include information indicative of software instructions to be executed by the workload management computing system 12. For example, given the same compilation workload, the workload request may instead point to the location of a code versioning system that serves as a repository for the codebase to be compiled.

In some implementations, the workload request can indicate particular characteristics of the requested workload and/or the requesting entity that provided the workload request. Characteristics indicated by the workload request can include a workload type(s), historic workload information (e.g., information related to prior requests of the same workload type submitted by the same entity, such as completion time, accuracy, etc.), an entity identifier (e.g., an identifier unique to the computing environment 10, a hardware identifier, etc.), an entity type (e.g., a user entity, an automated entity, etc.), etc.

A requesting entity 26 can provide a workload request 28 to the request-workload controller 22 via the interface 24. The workload request 28 can specify a particular workload. In some implementations, the workload request 28 can specify certain characteristics of the workload, and/or the requesting entity 26. To follow the depicted example, the workload request 28 can specify a workload with machine learning and cryptographic workload types (e.g., a workload to train a machine-learned model to perform cryptographic tasks, etc.). The workload request 28 can further indicate that the requesting entity 26 is a user entity type (e.g., a user or a process controlled by a user).

It should be noted that a requesting user entity such as the requesting entity 26 can, in some implementations, provide the workload request 28 provided as part of an automated process implemented by the user. The workload request 28 can still identify the requesting entity 26 as a user entity despite the automated nature of the workload request 28. In this manner, users can retain priority over automated entities for automated processes during time-sensitive development periods. The user entity can be differentiated from an automated entity based on credentials, prior transmissions, etc. For example, the workload request 28 may include user credentials to indicate the entity type of the requesting entity 26.

The workload request 28 can be received via the interface 24. In some implementations, the interface 24 can parse the workload request 28 to identify the workload and the workload/entity characteristics indicated by the workload request 28. Based on the identified workload, characteristic(s), and a rate limiting policy 30, the interface 24 can determine whether to accept the workload request 28 or to reject the workload request 28. Alternatively, in some implementations, the interface 24 can forward the workload request 28 to the request-workload controller 22 without parsing the request, or can indicate the requested workload to the request-workload controller 22 in some other manner.

More specifically, the request-workload controller 22 can include a rate limiting policy 30. The rate limiting policy 30 can control workload request fulfillment decision behavior for the request-workload controller 22 and/or the interface 24. A workload fulfillment decision generally refers to a decision whether to fulfill the workload requested by a workload request. A workload fulfillment decision can either be a decision to accept the workload request (and subsequently perform the requested workload) or to reject the workload request. When a workload fulfillment decision is made to accept a workload request, the workload can be performed, and any outputs of the workload can be provided to the requesting entity. When a workload fulfillment decision is made to reject a workload request, the workload management computing system 12 can indicate rejection of the workload request to the requesting entity (e.g., via the interface 24, etc.).

It should be noted that workload fulfillment decisions can be made directly by the workload management computing system 12 and/or indirectly via the interface 24. More specifically, in some implementations, the rate limiting policy 30 can control workload fulfillment decisions made by the interface 24. For example, based on an existing rate limit for a workload request, the interface 24 may be able to reject the workload request without forwarding the request to the workload management computing system 12. Alternatively, in some implementations, the workload management computing system 12 can receive the workload request from the interface 24 and can then make a workload fulfillment decision.

To do so, the rate limiting policy 30 can include rate limits for particular rate limiting targets. In some implementations, the rate limiting policy 30 can exclusively control behavior of the request-workload controller 22. Specifically, the rate limiting policy 30 can control a number of workload requests associated with a particular rate limiting target that the request-workload controller 22 accepts. For example, if the workload request 28 is associated with a rate limiting target that has already exceeded a threshold number of workload requests, the request-workload controller 22 can reject the workload request 28. Alternatively, in some implementations, the rate limiting policy 30 can control behavior of the 24, the workload handler 20, etc.

As described herein, a rate limiting target can refer to some characteristic of a workload and/or requesting entity that can be identified by or inferred from a workload request. In some implementations, the limiting target can be a characteristic of a workload, such as a workload type (e.g., a cryptographic workload, a machine learning workload, a compilation workload, a data retrieval/storage workload, etc.). Other examples of workload characteristics include a type or quantity of information included in or indicated by the workload request, metadata for the workload, etc. For example, assume that the rate limiting target is a cryptographic workload type. The rate limit for the cryptographic workload type may specify that a maximum of 100 workloads of the cryptographic workload type can be fulfilled within a period of time (e.g., 1 hour, etc.). Alternatively, the rate limit may restrict a number of GPUs available to fulfill the workloads, an amount of GPU time to be spent fulfilling the workloads, etc.

Additionally, or alternatively, in some implementations, a rate limiting target can be a characteristic of the requesting entity, such as an entity type. Generally, as described herein, an “entity type” refers to either a user or an automated process that provides a workload request. A user entity type can refer to a user, or an entity controlled by a user (e.g., an automated process implemented by the user, etc.). An automated entity can refer to an automated process that provides workload requests on a set schedule, or in a set pattern (e.g., in response to certain events, etc.). For example, an automated entity may routinely provide a workload request for a database backup workload at the end of every business day. For another example, an automated entity may routinely submit a workload request for a database backup workload in response to a certain quantity of information being changed within the database. Alternatively, other characteristics of the requesting entity can include a number of previous requests received from the entity, an amount and/or type of computing resources utilized to fulfill prior requests received from the entity, metadata related to the entity, etc.

However, entity types are not restricted to user entities and automated entities. Rather, an entity type can refer to any type or manner of classifier within a tiered priority system where workload fulfillment is prioritized for entities with certain credentials. For example, assume that the computing environment 10 is implemented for a software development organization. During periods of heavy development (e.g., prior to a feature implementation deadline), workload requests from developer entities (e.g., developers, accounts associated with developers, processes implemented by developers, etc.) can be prioritized over requests from quality assurance entities, and requests from certain developers (e.g., senior developers) can be prioritized over requests from other developers (e.g., first-year developers). Conversely, following periods of heavy development, requests from quality assurance entities can be prioritized over requests from developer entities. In such fashion, the request-workload controller 22 can dynamically adjust workload prioritization for particular types of entities.

Additionally, or alternatively, in some implementations, a rate limiting target can be a characteristic of the workload request, such as a type of request (e.g., a recurring request, an automated request, a manually submitted request, etc.).

In some implementations, rate limits can control the maximum quantity of workload requests associated with a particular rate limiting target to be fulfilled within a period of time. Additionally, or alternatively, in some implementations, rate limits can control a maximum quantity of computing resources available to fulfill workload requests associated with the rate limiting targets. Additionally, or alternatively, in some implementations, rate limits can control a type of computing resource available to fulfill workload requests associated with the rate limiting target.

Additionally, or alternatively, in some implementations, rate limits can control the behavior of the workload handler 20 when workloads associated with the rate limiting target are fulfilled. For example, given a particular workload type, the rate limit can control a quantity of computing resources (or quantity of a particular type of computing resources) available to fulfill requests of that type (e.g., a reserved pool of computing resources, a per-workload limit, etc.). For another example, given a particular entity type, the rate limit can control a quantity, type, or degree of computing resources available to fulfill workloads requested from entities of that particular type. For yet another example, given a particular requesting entity, the rate limit can control a number of workload requests to be fulfilled from the particular requesting entity.

In some implementations, a rate limit can be applied to a combination of rate limiting targets. For example, one rate limit may apply to workloads received from automated entity types, while a separate rate limit may apply to cryptographic workloads received from automated entity types. In some implementations, a combination of rate limits can be exclusive from the rate limits that constitute the combination of rate limits. To follow the previous example, assume that both of the rate limits specify a maximum limit of 10 workloads within a period of time. If the rate limit for cryptographic workloads from automated entities is exclusive, a cryptographic workload request from a non-automated entity type would not count towards the 10 workload limit for the cryptographic workloads from automated entities. Similarly, a non-cryptographic workload request from an automated entity type would not count towards the 10 workload limit for cryptographic workloads from automated entities.

The request-workload controller 22 can include resource utilization monitor 32. The resource utilization monitor 32 can monitor current and/or predicted utilization of the computing resources 18. For example, the resource utilization monitor 32 can iteratively ping or monitor utilization of computing resources 18 during fulfillment of workloads by the workload handler 20. The resource utilization monitor 32 can generate utilization information 34. The utilization information 34 can describe a current and/or predicted degree of utilization of the computing resources 18. The resource utilization monitor 32 can generate the utilization information 34 based on existing workloads being fulfilled by the workload handler 20, workload requests waiting in queue, and/or contextual information 36.

The contextual information 36 can describe prior operations performed, prior computational resource expenditure, and other metrics associated with fulfillment of prior workloads of particular workload types. For example, the contextual information 36 can specify that 80% of cryptographic workload types exhibit high degrees of GPU utilization. For another example, the contextual information 36 can specify that 93% of compiling workload types exhibit high degrees of CPU utilization for extended periods of time. In some implementations, the contextual information 36 can include information received from requesting entities, such as information included in workload requests, or reporting information received subsequent to fulfillment of a workload request. For example, if the workload request is a machine-learned model inference workload type, the requesting entity can report an evaluated degree of accuracy associated with the output of the workload.

The workload handler 20 can include a workload fulfillment module 38. The workload fulfillment module 38 can perform operations to fulfill workloads indicated by workload requests received via the interface 24, such as allocating the computing resources 18, utilizing the allocated computing resources to perform operations, causing utilization of the allocated computing resources, instructing computing devices to fulfill workloads, etc. Upon receipt of the workload request 28, the workload fulfillment module 38 can be fulfilling (or causing fulfillment of) existing workloads 40-1-40-N (generally, existing workloads 40). The existing workloads 40 can be fulfilled using the computing resources 18.

In some implementations, the workload fulfillment module 38 can utilize virtualization processes to fulfill workload requests. Specifically, the workload fulfillment module 38 can instantiate virtual machines and/or containers to fulfill particular workloads. For example, assume that the existing workload 40-1 is a parallelizable rendering workload. The workload fulfillment module 38 can instantiate a set of virtualized instances 42-1-42-N (generally, virtualized instances 42) that each complete a separate portion of the rendering workload to collectively fulfill the rendering workload request. In some implementations, the virtualized instances 42 can be configured for specific tasks (e.g., rendering tasks). For example, each of the virtualized instances 42 can be instantiated from a container image that includes rendering libraries to enable fulfillment of the rendering task. Additionally, or alternatively, in some implementations, the virtualized instances 42 can be general-purpose virtualized instances.

The request-workload controller 22 can include a rate limiting target identifier 44. The rate limiting target identifier 44 can identify a rate limiting target, and/or combination of rate limiting targets to apply rate limit modification(s). The rate limiting target identifier 44 can identify rate limiting targets in response to the resource utilization monitor 32 generating utilization information 34 indicating that a quantity of the computing resources 18 currently being utilized is greater than a threshold quantity of computing resources. The rate limiting target identifier 44 can generate rate limiting target information 46. The rate limiting target information 46 can indicate a rate limiting target 47, a current quantity of the computing resources 18 being utilized by existing workloads of the rate limiting target 47, and a threshold quantity of resources for workloads of the rate limiting target 47.

To follow the depicted example, the utilization information 34 generated using the resource utilization monitor 32 can indicate that existing workloads 40-1 and 40-2 are machine-learned model training workload types. The utilization information 34 can further indicate that the existing workload 40-1 is currently utilizing 45% of available computing resources and the existing workload 40-2 is currently utilizing 40% of available computing resources. The rate limiting target information 46 can identify workloads of the machine-learned model training workload type as the rate limiting target 47. The rate limiting target information 46 can further identify a current quantity of the computing resources 18 being utilized by workloads of the rate limiting target 47 (e.g., 85%) and the threshold quantity of computing resources (e.g., 80%).

In some implementations, the rate limit applied to a rate limiting target can control a Quality of Service (QOS) provided during fulfillment of the workload request. In some implementations, the QoS provided during workload fulfillment can control access to particular computing resources for workload fulfillment. For example, the rate limit for one rate limiting target can permit utilization of current generation GPUs for fulfillment of associated workloads while the rate limit for another rate limiting target can restrict utilization to prior generation GPUs, or GPUs with less bandwidth. Additionally, or alternatively, in some implementations, the QoS can control access to software resources available for workflow fulfillment. For example, the rate limit for one rate limiting target can permit utilization of modern licensed rendering libraries for fulfillment of rendering workloads while the rate limit for another rate limiting target can restrict utilization to less effective rendering libraries.

In some implementations, the rate limiting target identifier 44 can identify the rate limiting target 47 based on the utilization information 34. To follow the depicted example, the rate limiting target identifier 44 can identify the machine-learned model training workload type as the rate limiting target 47 due to existing workloads 40-1 and 40-2 of that type collectively utilizing a quantity of the computing resources 18 that is greater than a threshold quantity of computing resources (e.g., 85% vs 80%).

Alternatively, in some implementations, the rate limiting target identifier 44 can select a pre-determined rate limiting target 47, or can be instructed to identify a particular rate limiting target 47. For example, if machine-learned model training workloads are particularly important to the organization that implements the workload management computing system 12, the rate limiting target identifier 44 may receive instructions to refrain from selecting the machine-learned model training workloads as the rate limiting target 47. In such instances, the rate limiting target identifier 44 can select a “next best” target, a random target, etc. For another example, the rate limiting target identifier 44 can be configured to modify the rate limit for a particular type of user (e.g., an automated user) in response to a high degree of computing resource utilization.

In some implementations, the rate limiting target identifier 44 can identify a rate limiting target 47 predicted to minimize workload disruption. In some instances, the rate limiting target 47 predicted to minimize workload disruption can be different than the rate limiting target 47 associated with existing workloads utilizing the greatest quantity of the computing resources 18. For example, assume that the existing workload 40-1 utilizes 20% of available computing resources while the existing workload 40-2 utilizes 45% of available computing resources. If the existing workload 40-2 has a workload type that is resistant to delays, and the existing workload has A workload type that is time-sensitive, the rate limiting target identifier 44 can select the workload type associated with the existing workload 40-1 as the rate limiting target despite the existing workload 40-1 utilizing fewer resources than the existing workload 40-2.

The request-workload controller 22 can include a rate limit modifier 48. The rate limit modifier 48 can modify the rate limit of the rate limiting target 47 identified by the rate limiting target information 46. The rate limit modifier 48 can modify the rate limit by generating a modified rate limit 50. The rate limit modifier can replace an existing rate limit 49 for the rate limiting target 47 with the modified rate limit. The modified rate limit can be different than the existing rate limit 49.

In some implementations, the rate limit modifier 48 can generate the modified rate limit 50 by decreasing the existing rate limit 49 by a set amount or percentage. For example, the rate limit modifier 48 can be configured to generate a modified rate limit 50 that is 10% less than the existing rate limit 49 for a particular rate limiting target 47.

Additionally, or alternatively, in some implementations, the rate limit modifier 48 can generate the modified rate limit 50 based on the rate limiting target information 46, the workload request 28, the utilization information 34, the contextual information 36, etc. For example, assume that the default behavior of the rate limit modifier 48 is to generate the modified rate limit 50 by reducing an existing rate limit 49 by 10%. Further assume that the contextual information 36 indicates that a 10% reduction for the particular rate limiting target 47 has previously been insufficient. Based on the contextual information 36, the rate limit modifier 48 can generate the modified rate limit 50 by reducing the existing rate limit 49 by greater than 10%.

In some implementations, the request-workload controller 22 can include a workload prediction module 52. In some implementations, the workload prediction module 52 can predict a type and/or quantity of workloads to be requested based on the contextual information 36. For example, based on temporal information included in the contextual information 36 (e.g., a time of day, a day of the week, etc.), the workload prediction module 52 can predict that the request-workload controller 22 is likely to receive workload(s) of a particular type.

In some implementations, the rate limit modifier 48 can generate the modified rate limit 50 based on the workload prediction module 52, or an output of the workload prediction module 52. For example, assume that the workload prediction module 52 predicts that a high quantity of compilation workload requests will be received from requesting entities. Based on the utilization information 34, and the prediction, the rate limit modifier 48 can generate a modified rate limit 50 for compilation workloads that increases the computing resources allocated for compilation workloads, and can generate another modified rate limit 50 for some other workload type that correspondingly decreases the computing resources allocated for that workload type.

In some implementations, the request-workload controller 22 can include a computing resource change detector 51. The computing resource change detector 51 can detect changes to the computing resources 18. More specifically, the computing resources 18 available within the computing environment 10 are often distributed, and can change over time as existing computing resources fail or are deprecated and new computing resources are added. For example, in response to repeated workload congestion, the organization that implements the computing environment 10 may add additional GPUs to the computing resources 18. The computing resource change detector 51 can detect the addition of the GPUs, and can perform operations in response. Such operations can include re-calculating rate limits, informing the rate limit modifier 48, informing the resource utilization monitor 32, etc.

The rate limit modifier 48 can modify the rate limiting policy 30 by replacing the existing rate limit 49 for the rate limiting target 47 within the rate limiting policy 30 with the modified rate limit 50. For example, assume that the existing rate limit 49 for the rate limiting target 47 specifies a limit of 10% of total GPU resources for workloads associated with the rate limiting target 47 (e.g., machine-learned model training workload types). The rate limit modifier 48 can modify the rate limiting policy 30 by replacing the existing rate limit 49 of 10% with the modified rate limit 50 (e.g., 5% of total GPU resources, 3% of total GPU resources, etc.). In such fashion, the request-workload controller 22 can dynamically modify the rate limiting policy to increase utilization efficiency of the computing resources 18 while reducing the risk of over-utilization.

In some implementations, the workload handler 20 can cause fulfillment of the workload indicated by the workload request 28 in accordance with the modified rate limit 50. If fulfillment of the workload request 28 generates a workload output 54 (e.g., the output of a machine-learned model inference workload, etc.), the workload output 54 can be provided to the requesting entity. For example, if the modified rate limit 50 restricts workloads of the cryptographic workload type from GPU utilization, the workload handler 20 can cause fulfillment of the workload using the computing resources 18 other than GPUs. For another example, if the modified rate limit 50 forbids fulfillment of additional workloads of the cryptographic workload type, the workload handler 20 can cause rejection of the workload request 28.

In some implementations, the memory 16 can include a machine learning module 56. The machine learning module 56 can be utilized by other modules, components, processes, etc. described previously, such as the request-workload controller 22 and the workload handler 20. Specifically, in some implementations, the machine learning module 56 can include machine-learned models trained to identify rate limiting targets. For example, the machine learning module 56 can include a machine-learned target selection model that processes a corpus of input data (e.g., the contextual information 36, the workload request 28, the rate limiting policy 30, the utilization information 34, etc.) to generate an output that identifies one or more rate limiting targets.

Additionally, or alternatively, in some implementations, the machine learning module 56 can include a machine-learned model trained to modify rate limits for particular rate limiting targets. For another example, the machine learning module 56 can include a machine-learned rate limit modification model that processes a corpus of input data (e.g., the contextual information 36, the rate limiting target information 46, the rate limiting policy 30, the utilization information 34, etc.) to generate an output that includes, or otherwise indicates, the modified rate limit 50.

In some implementations, the workload management computing system 12 can make a workload fulfillment decision based on a particular rate limiting target. Specifically, rather than modifying a rate limit for a rate limiting target, the workload management computing system 12 can directly make a decision whether to accept or reject a workload request based on the identified rate limiting target for the workload request. For example, assume that the identified rate limiting target for a workload request is an entity type characteristic for the requesting entity. If the entity type characteristic is an automated entity type, the workload management computing system 12 may determine to reject the workload request.

Additionally, or alternatively, in some implementations, the workload management computing system 12 can make a workload fulfillment decision based on multiple rate limiting targets. To follow the previous example, assume that cryptographic workload types are strongly prioritized. If the rate limiting targets for the workload request were both the entity type characteristic and a workload type characteristic, and the workload type characteristic is cryptographic, the workload management computing system 12 can accept the workload request rather than reject the workload request.

In some implementations, subsequent to fulfillment of the workload indicated by the workload request 28, the resource utilization monitor 32 can generate an updated version of the utilization information 34. Based on the updated version of the utilization information 34, the request-workload controller 22 can determine to revert prior modifications to the rate limiting policy 30. For example, assume that the updated version of the utilization information 34 indicates that utilization of the computing resources 18 by workloads of the machine-learned model training workload type has fallen below the threshold quantity (e.g., from 85% to 30%). In response, the rate limit modifier 48 can revert the modifications to the rate limiting policy 30 by replacing the modified rate limit 50 with the previous rate limit that was previously applied to the rate limiting target 47 before replacement with the modified rate limit 50.

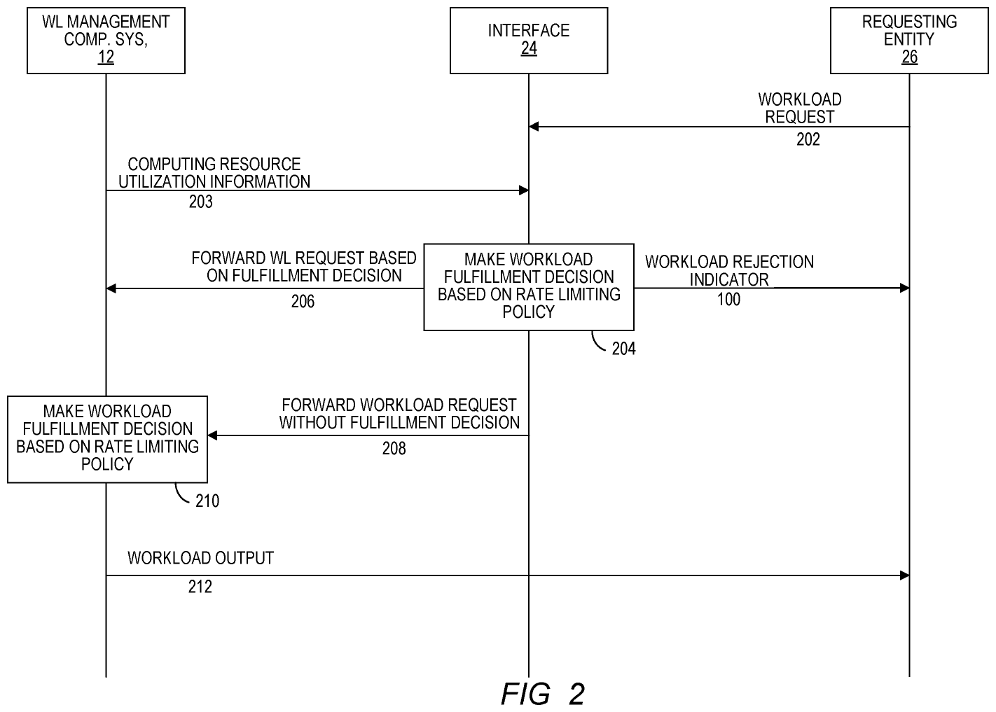

FIG. 2 is a communication flow diagram between a requesting entity and a workload management computing system mediated by a rate limiting policy according to some implementations of the present disclosure. It should be noted that, in some implementations, some (or all) of the actions or operations attributed to the interface 24 may be performed by the workload management computing system 12. For example, the workload management computing system 12 may implement the interface 24.

More specifically, at 202, the requesting entity 26 can provide the workload request 28 to the interface 24.

At 204, in some implementations, the interface 24 can evaluate the rate limiting policy 30. Based on the evaluation, the interface 24 can either accept the workload request 28 or reject the workload request 28. At 206, if the interface 24 accepts the workload request 28 based on the rate limiting policy 30, the interface 24 can forward the workload request 28 (or information derived from the workload request 28) to the workload management computing system 12 at 206. Alternatively, if the interface 24 rejects the workload request 28, at 208 the interface 24 can communicate rejection of the workload request 28 to the requesting entity 26.

Alternatively, in some implementations, the interface 24 can refrain from making the workload fulfillment decision for the workload request 28, and can instead forward the workload request 28 to the workload management computing system 12. At 210, the workload management computing system 12 can make the workload fulfillment decision rather than the interface 24.

In some implementations, prior to the interface 24 making the workload fulfillment decision, at 203, the workload management computing system 12 can provide the utilization information 34 to the interface 24. The interface 24 can make the workload fulfillment decision at 204 based on the utilization information 34, the workload request 28, and the rate limiting policy 30.

In some implementations, at 212, the workload management computing system 12 can forward the workload output 54 of the fulfilled workload to the requesting entity 26 (if applicable). In some implementations, the workload management computing system 12 can send the workload output 54 directly to the requesting entity 26. Alternatively, in some implementations, the workload management computing system 12 can send the workload output 54 to the interface 24, and the interface 24 can forward the workload output 54 to the requesting entity 26.

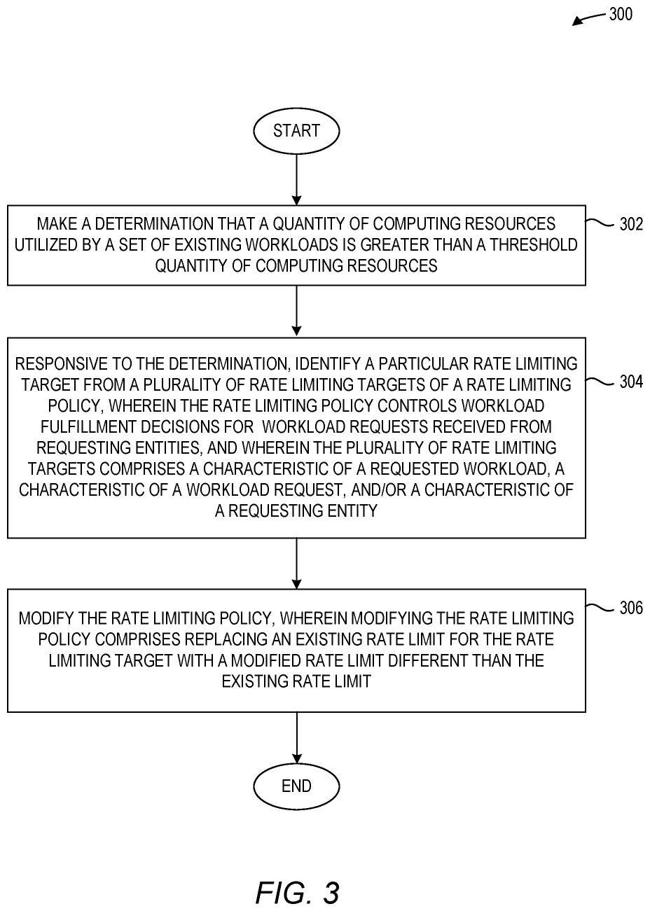

FIG. 3 is a flowchart of a method 300 for workload management via adaptive request rate limiting according to some implementations of the present disclosure. FIG. 3 will be discussed in conjunction with FIG. 1.

The workload management computing system 12 makes a determination that a quantity of the computing resources 18 utilized by the set of existing workloads 40 is greater than a threshold quantity of computing resources (FIG. 3, block 302). The workload management computing system 12 identifies a particular rate limiting target 47 from a plurality of rate limiting targets of the rate limiting policy 30, wherein the rate limiting policy 30 controls workload fulfillment decisions for workload requests (e.g., the workload request 28) received from the requesting entities (e.g., the requesting entity 26), wherein the rate limiting targets include a characteristic of the requested workload, the workload request, and/or the requesting entity (FIG. 3, Block 304). The workload management computing system 12 modifies the rate limiting policy 30, wherein modifying the rate limiting policy 30 includes replacing the existing rate limit 49 for the rate limiting target 47 with the modified rate limit 50 (FIG. 3, Block 306).

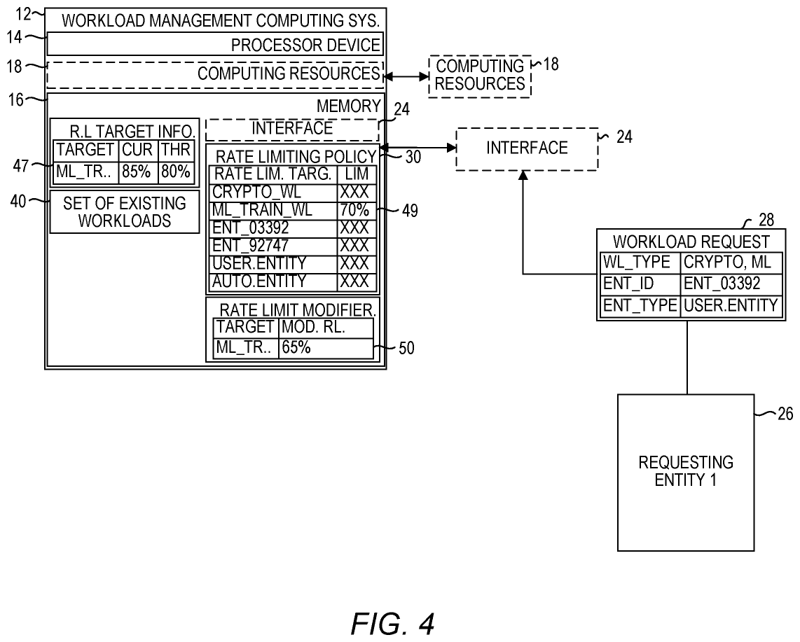

FIG. 4 is a simplified block diagram of the environment 10 illustrated in FIG. 1 according to one implementation of the present disclosure. The workload management computing system 12 includes a memory 16 and processor device(s) 14 coupled to the memory 16. The processor device(s) 14 are to make a determination that a quantity of computing resources 18 utilized by a set of existing workloads 40 is greater than a threshold quantity of the computing resources 18. The processor device(s) 14 are further to, responsive to the determination, identify a particular rate limiting target 47 from a plurality of rate limiting targets of a rate limiting policy 30, wherein the rate limiting policy 30 controls workload fulfillment decisions for workload requests (e.g., the workload request 28) from requesting entities (e.g., the requesting entity 26). The processor device(s) 14 are further to modify the rate limiting policy 30, wherein modifying the rate limiting policy 30 includes replacing an existing rate limit 49 for the rate limiting target 47 with a modified rate limit 50 different than the existing rate limit 49.

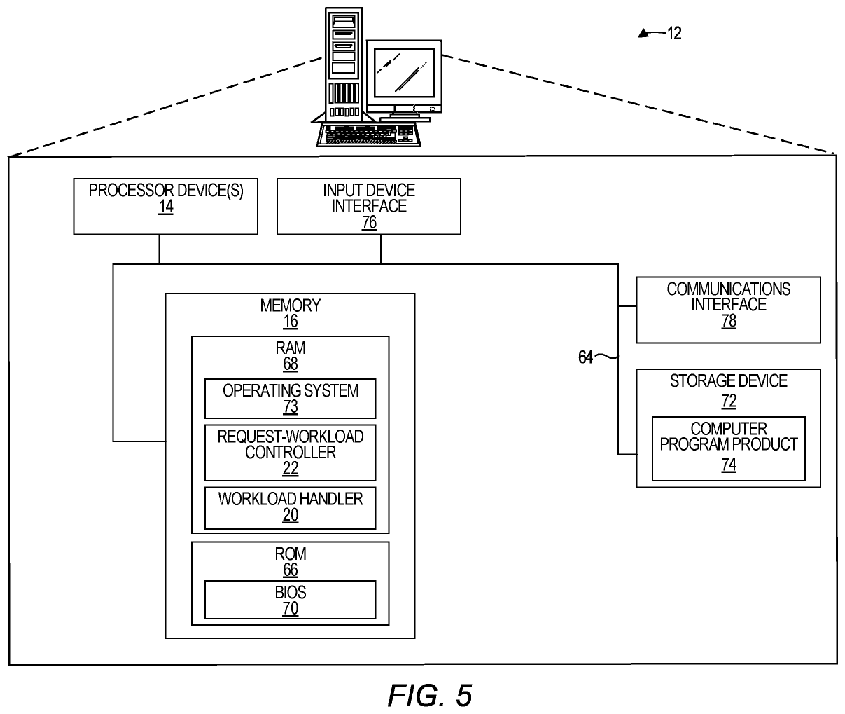

FIG. 5 is a block diagram of the workload management computing system 12 suitable for implementing examples according to one example. The workload management computing system 12 may comprise any computing or electronic device capable of including firmware, hardware, and/or executing software instructions to implement the functionality described herein, such as a computer server, a desktop computing device, a laptop computing device, a smartphone, a computing tablet, or the like. The workload management computing system 12 includes the processor device(s) 14, the memory 16, and a system bus 64. The system bus 64 provides an interface for system components including, but not limited to, the memory 16 and the processor device(s) 14. The processor device(s) 14 can be any commercially available or proprietary processor(s).

The system bus 64 may be any of several types of bus structures that may further interconnect to a memory bus (with or without a memory controller), a peripheral bus, and/or a local bus using any of a variety of commercially available bus architectures. The memory 16 may include non-volatile memory 66 (e.g., read-only memory (ROM), erasable programmable read-only memory (EPROM), electrically erasable programmable read-only memory (EEPROM), etc.), and volatile memory 68 (e.g., random-access memory (RAM)). A basic input/output system (BIOS) 70 may be stored in the non-volatile memory 66 and can include the basic routines that help to transfer information between elements within the workload management computing system 12. The volatile memory 68 may also include a high-speed RAM, such as static RAM, for caching data.

The workload management computing system 12 may further include or be coupled to a non-transitory computer-readable storage medium such as a storage device 72, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 72 and other drives associated with computer-readable media and computer-usable media may provide non-volatile storage of data, data structures, computer-executable instructions, and the like.

A number of modules can be stored in the storage device 72 and in the volatile memory 68, including an operating system 71 and one or more program modules, such as the request-workload controller 22, and/or the workload handler 20, which may implement the functionality described herein in whole or in part. All or a portion of the examples may be implemented as a computer program product 74 stored on a transitory or non-transitory computer-usable or computer-readable storage medium, such as the storage device 72, which includes complex programming instructions, such as complex computer-readable program code, to cause the processor device(s) 14 to carry out the steps described herein. Thus, the computer-readable program code can comprise software instructions for implementing the functionality of the examples described herein when executed on the processor device(s) 14. The processor device(s) 14, in conjunction with the request-workload controller 22 and/or the workload handler 20 in the volatile memory 68, may serve as a controller, or control system, for the workload management computing system 12 that is to implement the functionality described herein.

Because the request-workload controller 22 is a component of the workload management computing system 12, functionality implemented by the request-workload controller 22 may be attributed to the workload management computing system 12 generally. Moreover, in examples where the request-workload controller 22 comprises software instructions that program the processor device(s) 14 to carry out functionality discussed herein, functionality implemented by the request-workload controller 22 may be attributed herein to the processor device(s) 14.

It is further noted that while the request-workload controller 22 and the workload handler 20 are shown as separate components, in other implementations, the request-workload controller 22 and the workload handler 20 could be implemented in a single component or could be implemented in a greater number of components than two.

An operator, such as a user, may also be able to enter one or more configuration commands through a keyboard (not illustrated), a pointing device such as a mouse (not illustrated), or a touch-sensitive surface such as a display device. Such input devices may be connected to the processor device(s) 14 through an input device interface 76 that is coupled to the system bus 64 but can be connected by other interfaces such as a parallel port, an Institute of Electrical and Electronic Engineers (IEEE) 1394 serial port, a Universal Serial Bus (USB) port, an IR interface, and the like. The workload management computing system 12 may also include a communications interface 78 suitable for communicating with the network as appropriate or desired. The workload management computing system 12 may also include a video port configured to interface with the display device, or to provide information to the user.

Individuals will recognize improvements and modifications to the preferred examples of the disclosure. All such improvements and modifications are considered within the scope of the concepts disclosed herein and the claims that follow.

What is claimed is:

1. A method, comprising:
making, by a workload management computing system comprising one or more processor devices, a determination that a quantity of computing resources utilized by a set of existing workloads is greater than a threshold quantity of the computing resources;
responsive to the determination, identifying, by the workload management computing system, a particular rate limiting target from a plurality of rate limiting targets of a rate limiting policy, wherein the rate limiting policy controls workload fulfillment decisions for workload requests received from requesting entities, and wherein the plurality of rate limiting targets comprises:
a characteristic of a requested workload;
a characteristic of a workload request; or
a characteristic of a requesting entity; and
modifying, by the workload management computing system, the rate limiting policy, wherein modifying the rate limiting policy comprises replacing an existing rate limit for the rate limiting target with a modified rate limit different than the existing rate limit.

2. The method of claim 1, wherein, prior to making the determination, the method comprises:
receiving, by the workload management computing system, a workload request from a requesting entity via an interface, wherein the workload request is indicative of the characteristic of the requesting entity.

3. The method of claim 2, wherein modifying, by the computing system, the rate limiting policy comprises:
modifying, by the workload management computing system, the rate limiting policy, wherein the modified rate limit for the rate limiting target controls at least one of:
a maximum quantity of workload requests associated with the rate limiting target to be fulfilled within a period of time;
a maximum quantity of computing resources available to fulfill workload requests associated with the rate limiting target; or
a type of computing resource available to fulfill workload requests associated with the rate limiting target.

4. The method of claim 3, wherein the method further comprises:
causing, by the workload management computing system, fulfillment of the workload indicated by the workload request in accordance with the modified rate limit for the rate limiting target.

5. The method of claim 4, wherein modifying the rate limiting policy comprises:
modifying, by the workload management computing system, the rate limiting policy, wherein the modified rate limit for the rate limiting target controls the type of computing resource available to fulfill the workload requests associated with the rate limiting target, and wherein the type of computing resource comprises a first resource type of a plurality of resource types; and
wherein causing the fulfillment of the workload indicated by the workload request in accordance with the modified rate limit comprises:
causing, by the workload management computing system, fulfillment of the workload indicated by the workload request using one or more of the plurality of resource types other than the first resource type.

6. The method of claim 5, wherein the first resource type comprises a Graphics Processing Unit (GPU).

7. The method of claim 3, wherein identifying the rate limiting target comprises identifying, by the workload management computing system, the rate limiting target from the plurality of rate limiting targets, wherein the characteristic of the requested entity comprises the entity type associated with the requesting entity, and wherein the entity type associated with the requesting entity comprises an automated entity type.

8. The method of claim 7, wherein modifying the rate limiting policy comprises:
replacing, by the workload management computing system, the existing rate limit for the rate limiting target with the modified rate limit, wherein the modified rate limit comprises a maximum quantity of workload requests from entities of the automated entity type to be fulfilled within the period of time; and
wherein the method further comprises:
causing, by the workload management computing system, rejection of the workload request in accordance with the maximum quantity of workload requests from entities of the automated entity type to be fulfilled within the period of time.

9. The method of claim 7, wherein modifying the rate limiting policy comprises:
replacing, by the workload management computing system, the existing rate limit for the rate limiting target with the modified rate limit, wherein the modified rate limit comprises a maximum quantity of computing resources available to fulfill workload requests from entities of the automated entity type; and
wherein the method further comprises:
causing, by the workload management computing system, fulfillment of the workload indicated by the workload request using a quantity of computing resources less than the maximum quantity of computing resources available to fulfill the workload requests from the entities of the automated entity type.

10. The method of claim 2, wherein the method further comprises:
causing, by the workload management computing system, rejection of the workload request based on the modified rate limit for the rate limiting target.

11. The method of claim 1, wherein the method further comprises:
subsequent to modifying the rate limiting policy, detecting, by the workload management computing system, that a current quantity of computing resources utilized by a current set of existing workloads is less than the threshold quantity of computing resources; and
responsive to detecting that the current quantity of computing resources utilized by a current set of existing workloads is less than the threshold quantity of computing resources, reverting, by the workload management computing system, prior modifications to the rate limiting policy.

12. The method of claim 1, wherein identifying the rate limiting target from the plurality of rate limiting targets comprises:
responsive to the determination, identifying, by the workload management computing system, the rate limiting target from the plurality of rate limiting targets based at least in part on contextual information, wherein the contextual information is descriptive of one or more operations performed to fulfill the workload indicated by the workload request.

13. The method of claim 1, wherein the plurality of rate limiting targets comprises:
a particular workload type;
a particular workload request type;
a particular requesting entity; or
a particular requesting entity type.

14. A workload management computing system, comprising:
a memory; and
one or more processor devices coupled to the memory to:
make a determination that a quantity of computing resources utilized by a set of existing workloads is greater than a threshold quantity of the computing resources;
responsive to the determination, identify a particular rate limiting target from a plurality of rate limiting targets of a rate limiting policy, wherein the rate limiting policy controls workload fulfillment decisions for workload requests received from requesting entities, and wherein the plurality of rate limiting targets comprises:
a characteristic of a requested workload;
a characteristic of a workload request; or
a characteristic of a requesting entity; and
modify the rate limiting policy, wherein modifying the rate limiting policy comprises replacing an existing rate limit for the rate limiting target with a modified rate limit different than the existing rate limit.

15. The workload management computing system of claim 14, wherein, prior to making the determination, the one or more processor devices are coupled to the memory to:
receive a workload request from a requesting entity via an interface, wherein the workload request is indicative of a workload of the particular workload type.

16. The workload management computing system of claim 15, wherein modifying the rate limiting policy comprises:
modifying the rate limiting policy, wherein the modified rate limit for the rate limiting target controls at least one of:
a maximum quantity of workload requests associated with the rate limiting target to be fulfilled within a period of time;
a maximum quantity of computing resources available to fulfill workload requests associated with the rate limiting target; or
a type of computing resource available to fulfill workload requests associated with the rate limiting target.

17. The workload management computing system of claim 16, wherein the one or more processor devices are further coupled to the memory to:
cause fulfillment of the workload indicated by the workload request in accordance with the modified rate limit for the rate limiting target.

18. The workload management computing system of claim 17, wherein modifying the rate limiting policy comprises:
modifying the rate limiting policy, wherein the modified rate limit for the rate limiting target controls the type of computing resource available to fulfill the workload requests associated with the rate limiting target, and wherein the type of computing resource comprises a first resource type of a plurality of resource types; and
wherein causing the fulfillment of the workload indicated by the workload request in accordance with the modified rate limit comprises:
causing fulfillment of the workload using one or more of the plurality of resource types other than the first resource type.

19. The workload management computing system of claim 18, wherein the first resource type comprises a Graphics Processing Unit (GPU).

20. A non-transitory computer-readable storage medium that includes executable instructions to cause one or more processor devices to:
receive a workload request from a requesting entity via an interface, wherein the workload request is indicative of a particular workload;
make a determination that a quantity of computing resources utilized by a set of existing workloads is greater than a threshold quantity of the computing resources;
responsive to the determination, select a particular rate limiting target from a plurality of rate limiting targets for the workload request, and wherein the plurality of rate limiting targets comprises:
a characteristic of a requested workload;
a characteristic of a workload request; or
a characteristic of a requesting entity; and
make a workload fulfillment decision based on the particular rate limiting target, wherein the workload fulfillment decision comprises a decision whether to accept the workload request or reject the workload request.
